(19) United States
(12) Patent Application Publication
(10) Pub. No.: US 2014/0270392 A1
(43) Pub. Date: Sep. 18, 2014

(54) Apparatus and Method for Measuring Road Flatness

(71) Applicant: Junghun Kim, Seoul (KR)

(72) Inventor: Junghun Kim, Seoul (KR)

(73) Assignee: LG INNOTEK CO., LTD., Seoul (KR)

(21) Appl. No.: 14/350,255

(22) PCT Filed: Aug. 23, 2012
(86) PCT No.: PCT/KR2012/006696

§ 371 Date: May 22, 2014

(30) Foreign Application Priority Data
Oct. 6, 2011 (KR) 10-2011-0101577

(51) Int. Cl. G06T 7/40; G06K 9/00

(52) U.S. Cl. CPC G06T 7/40; G06K 9/00791; G06T 2207/30256
USPC 382/108

(57) ABSTRACT

According to exemplary embodiments of the present invention, the apparatus and method for measuring road flatness are provided, the method comprising obtaining an image of a road, obtaining the road flatness by dividing the image of the road into a plurality of areas, calculating an average brightness from each of the plurality of areas, and comparing the average brightness from each of the plurality of areas with a threshold, and displaying an image relative to the road flatness.

### TECHNICAL FIELD

The teachings in accordance with exemplary embodiments of this invention relate generally to an apparatus and method for measuring road flatness.

### BACKGROUND ART

Recently, many devices have been provided to consumers to cater to consumer satisfaction and convenience regarding power performance of a vehicle. One of the examples including a current trend is a popularized dissemination of an integrated display device capable of grasping a vehicle status and front/rear cameras at a glance.

Driving capabilities may be enhanced when a vehicle driver is aware of conditions on a roadway that possess potential hazards when a vehicle is traveling along the roadway. The earlier the driver can identify a potential roadway hazard, the earlier the driver is able to take precautions to avoid the potential roadway hazard.

In this case, the driver can view an obstacle about a vehicle that cannot be viewed through the front/rear cameras and display device during travelling to a front or a rear side, and can determine a distance to the obstacle. A conventional device or method simply provided only front/rear images during travelling to front/rear side, such that needs arise to provide an apparatus or a method capable of determining a road status so that a driver or a user can easily grasp an obstacle.

### DISCLOSURE OF INVENTION

### Technical Problem

Accordingly, embodiments of the present invention may relate to an apparatus and method for measuring a road flatness that substantially obviates one or more of the above disadvantages/problems due to limitations and disadvantages of related art, by measuring road flatness via an image obtained from a front or rear camera of a vehicle and displaying on a display screen, whereby a user can be notified in advance of a road condition to proactively prevent occurrence of an accident.

Technical problems to be solved by the present invention are not restricted to the above-mentioned, and any other technical problems not mentioned so far will be clearly appreciated from the following description by skilled in the art.

### Solution to Problem

An apparatus for measuring road flatness according to one exemplary embodiment of the present invention is provided, the apparatus comprising: an image sensor for obtaining an image of a road; a processor for processing the image of the road; and an encoder for outputting the image of the road to a display unit, wherein the processor uses average brightness of the image of the road to obtain the road flatness.

Preferably, but not necessarily, the processor divides the image of the road into a plurality of areas to calculate the average brightness of the plurality of areas.

Preferably, but not necessarily, the processor compares the average brightness of the plurality of areas with a threshold to obtain the road flatness.

Preferably, but not necessarily, the processor generates a warning message to an area where the average brightness is smaller than the threshold, as a result of comparison between the average brightness of the plurality of areas and the threshold.

Preferably, but not necessarily, the processor generates an image relative to the road flatness to an area where the average brightness is smaller than the threshold, as a result of comparison between the average brightness of the plurality of areas and the threshold.

Preferably, but not necessarily, the processor detects a road area from the plurality of areas to calculate the average brightness of the road area.

Preferably, but not necessarily, the processor compares the average brightness of the road area with the threshold to obtain the road flatness.

Preferably, but not necessarily, the processor generates a warning message to an area where the average brightness is smaller than the threshold, as a result of comparison between the average brightness of the road area and the threshold.

Preferably, but not necessarily, the processor generates an image relative to the road flatness to an area where the average brightness is smaller than the threshold, as a result of comparison between the average brightness of the area and the threshold.

Preferably, but not necessarily, the processor generates an image relative to the road flatness.

Preferably, but not necessarily, the processor synthesizes the image of the road with the image relative to the road flatness.

There is provided a method for measuring road flatness according to one exemplary embodiment of the present invention, the method comprising: obtaining an image of a road; obtaining the road flatness by dividing the image of the road into a plurality of areas, calculating an average brightness from each of the plurality of areas, and comparing the average brightness from each of the plurality of areas with a threshold; and displaying an image relative to the road flatness.

Preferably, but not necessarily, the step of obtaining the road flatness comprises detecting a road area from the plurality of areas, calculating an average brightness of the road area, comparing the average brightness of the road area with the threshold, and obtaining the road flatness.

Preferably, but not necessarily, the step of displaying an image relative to the road flatness includes generating an image relative to the road flatness of an area where the average brightness of the road area is smaller than the threshold.

### Advantageous Effects of Invention

The apparatus and method for measuring road flatness according to the exemplary embodiments of the present invention have advantageous effects in that conditions on a roadway are grasped in real-time when a vehicle is traveling along the roadway, in addition to obtainment of a front or rear view, which is one of essential purposes of a front or a rear camera, and information of the current conditions of the roadway is provided to a driver, whereby potential roadway hazards or accidents can be prevented in advance through cautions to over-speed/forward driving at a hazardous roadway.

### BRIEF DESCRIPTION OF DRAWINGS

FIG. 1 is a schematic block diagram illustrating a camera module and a display module according to an exemplary embodiment of the present invention.

FIG. 2 is a schematic view of a screen displayed on an actual display module according to an exemplary embodiment of the present invention.

FIG. 3 is a flowchart illustrating a method for measuring road flatness according to an exemplary embodiment of the present invention.

### BEST MODE FOR CARRYING OUT THE INVENTION

The following description is not intended to limit the invention to the form disclosed herein. Consequently, variations and modifications commensurate with the following teachings, and skill and knowledge of the relevant art are within the scope of the present invention. The embodiments described herein are further intended to explain modes known of practicing the invention and to enable others skilled in the art to utilize the invention in such, or other embodiments and with various modifications required by the particular application(s) or use(s) of the present invention.

The disclosed embodiments and advantages thereof are best understood by referring to FIGS. 1-3 of the drawings, like numerals being used for like and corresponding parts of the various drawings. Other features and advantages of the disclosed embodiments will be or will become apparent to one of ordinary skill in the art upon examination of the following figures and detailed description. It is intended that all such additional features and advantages be included within the scope of the disclosed embodiments, and protected by the accompanying drawings. Further, the illustrated figures are only exemplary and not intended to assert or imply any limitation with regard to the environment, architecture, or process in which different embodiments may be implemented. Accordingly, the described aspect is intended to embrace all such alterations, modifications, and variations that fall within the scope and novel idea of the present invention.

It will be understood that the terms “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. That is, the terms “including”, “includes”, “having”, “has”, “with”, or variants thereof are used in the detailed description and/or the claims to denote non-exhaustive inclusion in a manner similar to the term “comprising”.

Furthermore, “exemplary” is merely meant to mean an example, rather than the best. It is also to be appreciated that features, layers and/or elements depicted herein are illustrated with particular dimensions and/or orientations relative to one another for purposes of simplicity and ease of understanding, and that the actual dimensions and/or orientations may differ substantially from that illustrated. That is, in the drawings, the size and relative sizes of layers, regions and/or other elements may be exaggerated or reduced for clarity. Like numbers refer to like elements throughout and explanations that duplicate one another will be omitted. Now, the present invention will be described in detail with reference to the accompanying drawings.

Words such as “thus,” “then,” “next,” “therefore”, etc. are not intended to limit the order of the processes; these words are simply used to guide the reader through the description of the methods.

It will be understood that when an element is referred to as being “connected” or “coupled” to another element, it can be directly connected or coupled to the other elements or intervening elements may be present. In contrast, when an element is referred to as being “directly connected” or “directly coupled” to another element, there are no intervening elements present.

It will be understood that, although the terms first, second, etc. may be used herein to describe various elements, these elements should not be limited by these terms. These terms are only used to distinguish one element from another. For example, a first region/layer could be termed a second region/layer, and, similarly, a second region/layer could be termed a first region/layer without departing from the teachings of the disclosure.

The terminology used herein is for the purpose of describing particular embodiments only and is not intended to be limiting of the general inventive concept. As used herein, the singular forms “a”, “an” and “the” are intended to include the plural forms as well, unless the context clearly indicates otherwise. In addition, the terms “-er”, “-or”, “part” and “module” described in the specification mean units for processing at least one function and operation and can be implemented by hardware components or software components, and combinations thereof.

Now, the apparatus and method for measuring the road flatness according to exemplary embodiments of the present invention will be described in detail with reference to the accompanying drawings.

FIG. 1 is a schematic block diagram illustrating a camera module (100) for measuring road flatness and a display module (110) for displaying information on the measured road flatness according to an exemplary embodiment of the present invention.

The camera module (100) may comprise an image sensor (101) for capturing or obtaining an image of a front or a rear side of a vehicle, a processor (102) for processing the image captured or obtained by the image sensor (101), and an encoder (103) for converting or outputting the image processed by the processor (102) in a format for displaying the image on the display module (110).

The image sensor (101) is mounted on a camera module (100) formed on a front side, a rear side and/or lateral side of the vehicle, and can obtain an image photographed or captured by a lens of the camera module. The processor (102) is a unit for image-processing the photographed or captured image, and can control a general operation of the camera module (100) in addition to image-processing. The processor 102) can image-process the image photographed or captured by image sensor (101) in response to a series of algorithms and output information on road flatness within the image. The outputted information may be converted by the encoder (103) to be displayed on the display module (110).

The display module (110) is a type of monitors mounted on the vehicle and operated in association with an audio device and/or a navigation device. The display module (110) is a device for displaying information, such that there is no particular limit to type or characteristic thereof.

Now, measuring or calculating process of road flatness according to an exemplary embodiment of the present invention will be described with reference to accompanying drawings.

In the day time travelling, a driver can visually and personally check the road conditions at the front and rear sides of a vehicle, as the driver's view field can be fully secured. However, in the night time travelling, the driver has a difficulty in securing road conditions at the front and rear sides of the vehicle using the driver's naked eye, although lighting devices such as street light and head lamps provide views for the driver.

Thus, the exemplary embodiment of the present invention has introduced a concept of “night mode” to help the driver grasp road conditions in case of night travelling. A ‘road condition grasp’ (described later) including measurement or calculation of road flatness may be provided for “night mode”, and it should be apparent to the skilled in the art that the road condition grasp is not always used for the “night mode” but may be used in the daytime.

The image sensor (101) mounted on the camera module (100) of the vehicle in the night mode can continuously and in real time photograph or obtain a direction faced by the lens of the camera module (100), that is, a front image or a rear image of the vehicle. A distance range as to how far the front or rear image is distanced from the vehicle may be provided to the driver according to decision by a user environment.

The processor (102) may receive the front or rear image obtained or photographed by the image sensor (101). The processor (102) image-processes the received image, and displays the received image on the display module (110). The processor (102) may divide the image provided by the image sensor (101) into a plurality (e.g., N numbers) of areas. For example, the provided image may include a road, surrounding scenery and/or objects on the road. The processor (102) may detect a road area from the plurality of areas. The processor (102) may calculate an average brightness relative to the detected area using the road area in the plurality of areas.

In general, if a road is bent or formed with a hole, an image that has photographed the road may be relatively displayed in a dark manner to make brightness decreased, which means that the road flatness is low. Meanwhile, if the road is smoothly paved, the image that has photographed the road may be relatively displayed in a bright manner to make brightness increased, which means that the road flatness is high. Furthermore, if there is a sudden change in brightness in the road image, it can be expected that the road flatness has suddenly changed, such that the detection of changes must be and can be detected.

Therefore, the processor (102) may use a threshold for comparing relative brightness in the exemplary embodiment of the present invention. Thus, if an average brightness at a relevant area is lower than the threshold, it means that the road flatness is low, and if an average brightness at a relevant area is higher than the threshold, it means that the road flatness is high. The processor (102) can obtain front road flatness or rear road flatness using a relationship between the average brightness of the image area and road flatness.

The processor (102) may use the obtained road flatness to generate an image relative to the road flatness. The image relative to the road flatness may be synthesized with the road image photographed or captured by the image sensor (101). The synthesized image may be converted by the encoder (103) and displayed on the display module (110).

The image relative to the road flatness, in displaying a relevant area relative to all road areas, may be displayed in a shape of a square with different colors. For example, the road flatness may be divided into three ranges (e.g., large, medium and small), and a large road flatness may be displayed in a blue square, a medium road flatness may be displayed in a yellow square, and a small road flatness may be displayed in a red square.

Furthermore, instead of generating images to the road flatness of all areas (N numbers), only an image of road flatness that requires awareness or caution to the driver due to being determined as low road flatness may be generated. In this case, the road flatness corresponds to “small”, such that only a red square may be displayed. The display of the road flatness will be additionally described later with reference to FIG. 2.

Furthermore, the processor (102) may generate a warning message, if it is determined that the front road flatness is low as a result of comparison between the average brightness and threshold of each area. The generated warning message may be displayed along with the synthesized image. In addition, the warning message as well as a warning sound may be outputted in association with a speaker mounted at the vehicle.

FIG. 2 is a schematic view of a screen displayed on an actual display module according to an exemplary embodiment of the present invention, where, it should be noted that the screen is displayed by the road image captured or obtained by the image sensor being synthesized by the image of the road flatness. Furthermore, it can be noted that only an area, where road flatness is determined as being low in the front image, is displayed in a square. The driver can pay attention to the road conditions through the road flatness displayed on the display module by checking in advance the front road flatness.

### Mode for the Invention

FIG. 3 is a flowchart illustrating a method for measuring road flatness according to an exemplary embodiment of the present invention, where the method may comprise obtaining of photographing a road image in front or rear side of a vehicle (S310), processing the road image (S320), and displaying the processed road image on a display module (S330).

The step (S310) of obtaining the road flatness may be performed by an image sensor of a camera module (100). The step (S320) of processing the road image may comprise dividing the obtained road image into a plurality (N numbers) of areas (S320), calculating an average brightness of each of the plurality of areas (S322), comparing the average brightness of each of the plurality of areas with a threshold (S323), and calculating or obtaining the road flatness of each area (S324). The process of calculating the road flatness has been already described with reference to FIG. 1.

Furthermore, the step of processing the road image (S320) may generate an image to the road flatness separately in order to display the calculated or obtained road flatness. The image of the road flatness thus generated may be synthesized with the hitherto captured or obtained road image to be displayed on the display module. The image to the road flatness may display flatness of all road areas, or alternatively may display only an area where the road flatness is determined as being low.

The step of displaying the synthesized image on the display module (S330) may comprise converting data processed by the processor (e.g., synthesized image) to a format adequate to the display module.

The previous description of the present invention is provided to enable any person skilled in the art to make or use the invention. Various modifications to the invention will be readily apparent to those skilled in the art, and the generic principles defined herein may be applied to other variations without departing from the spirit or scope of the invention. Thus, the invention is not intended to limit the examples described herein, but is to be accorded the widest scope consistent with the principles and novel features disclosed herein.

### INDUSTRIAL APPLICABILITY

As apparent from the foregoing, the apparatus and method for measuring the road flatness according to the exemplary embodiments of the present invention have industrial applicability in that conditions on a roadway are grasped in real-time when a vehicle is traveling along the roadway, in addition to obtainment of a front or rear view, which is one of essential purposes of a front or a rear camera, and information of the current conditions of the roadway is provided to a driver, whereby potential roadway hazards or accidents can be prevented in advance through cautions to overspeed/forward driving at a hazardous roadway.

1. An apparatus for measuring road flatness, the apparatus comprising: an image sensor for obtaining an image of a road; a processor for processing the image of the road; and an encoder for outputting the image of the road to a display unit, wherein the processor uses average brightness of the image of the road to obtain the road flatness.

2. The apparatus of claim 1, wherein the processor divides the image of the road into a plurality of areas to calculate the average brightness of the plurality of areas.

3. The apparatus of claim 2, wherein the processor compares the average brightness of the plurality of areas with a threshold to obtain the road flatness.

4. The apparatus of claim 3, wherein the processor generates a warning message to an area where the average brightness is smaller than the threshold, as a result of comparison between the average brightness of the plurality of areas and the threshold.

5. The apparatus of claim 3, wherein the processor generates an image relative to the road flatness to an area where the average brightness is smaller than the threshold, as a result of comparison between the average brightness of the plurality of areas and the threshold.

6. The apparatus of claim 2, wherein the processor detects a road area from the plurality of areas to calculate the average brightness of the road area.

7. The apparatus of claim 6, wherein the processor compares the average brightness of the road area with the threshold to obtain the road flatness.

8. The apparatus of claim 7, wherein the processor generates a warning message to an area where the average brightness is smaller than the threshold, as a result of comparison between the average brightness of the road area and the threshold.

9. The apparatus of claim 7, wherein the processor generates an image relative to the road flatness to an area where the average brightness is smaller than the threshold, as a result of comparison between the average brightness of the area and the threshold.

10. The apparatus of claim 1, wherein the processor generates an image relative to the road flatness.

11. The apparatus of claim 10, wherein the processor synthesizes the image of the road with the image relative to the road flatness.

12. A method for measuring road flatness, the method comprising:
obtaining an image of a road;
obtaining the road flatness by dividing the image of the road into a plurality of areas, calculating an average brightness from each of the plurality of areas, and comparing the average brightness from each of the plurality of areas with a threshold; and
displaying an image relative to the road flatness.

13. The method of claim 12, wherein the step of obtaining the road flatness comprises detecting a road area from the plurality of areas, calculating an average brightness of the road area, comparing the average brightness of the road area with the threshold, and obtaining the road flatness.

14. The method of claim 12, wherein the step of displaying an image relative to the road flatness includes generating an image relative to the road flatness of an area where the average brightness of the road area is smaller than the threshold.
